(19) United States
(12) Patent Application Publication
(10) Pub. No.: US 2016/0353940 A1
(43) Pub. Date: Dec. 8, 2016

(54) LIGHT EMITTING SHOWER CURTAIN ASSEMBLY

(71) Applicant: Diane Smith, Jacksonville, AR (US)

(72) Inventor: Diane Smith, Jacksonville, AR (US)

(21) Appl. No.: 14/732,279

(22) Filed: Jun. 5, 2015

(51) Int. Cl. A47K 3/38; F21V 33/00; F21K 2/00

(52) U.S. Cl. CPC A47K 3/38; F21K 2/00; F21V 33/004; F21W 2121/00

(57) ABSTRACT

A light emitting shower curtain assembly includes a panel that is flexible and has an upper edge, a bottom edge, a first side edge and a second side edge. The panel includes a first side and a second side. The panel has a plurality of apertures therein extending into the first side and outwardly from the second side. The apertures are aligned with each other along a line extending through the first and second side edges and are positioned adjacent to the upper edge. The panel comprises a phosphorescent material such that the panel emits light after is exposed to light.

### BACKGROUND OF THE DISCLOSURE

### Field of the Disclosure

The disclosure relates to shower curtain devices and more particularly pertains to a new shower curtain device for illuminating a bathroom with an illuminated shower curtain.

### SUMMARY OF THE DISCLOSURE

An embodiment of the disclosure meets the needs presented above by generally comprising a panel that is flexible and has an upper edge, a bottom edge, a first side edge and a second side edge. The panel includes a first side and a second side. The panel has a plurality of apertures therein extending into the first side and outwardly from the second side. The apertures are aligned with each other along a line extending through the first and second side edges and are positioned adjacent to the upper edge. The panel comprises a phosphorescent material such that the panel emits light after is exposed to light.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a light emitting shower curtain assembly according to an embodiment of the disclosure.

FIG. 2 is a perspective broken view of an embodiment of the disclosure.

FIG. 3 is a cross-sectional view of an embodiment of the disclosure taken along line 3-3 of FIG. 2.

FIG. 4 is a front in-use view of an embodiment of the disclosure.

### DESCRIPTION OF THE PREFERRED EMBODIMENT

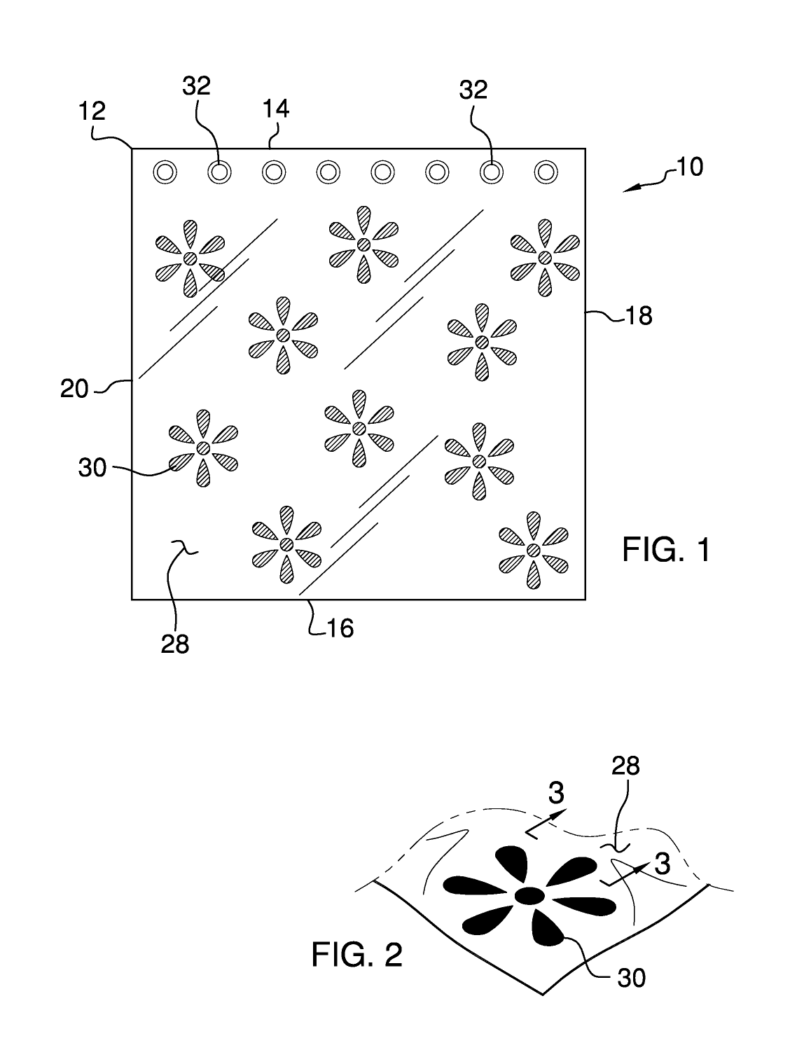

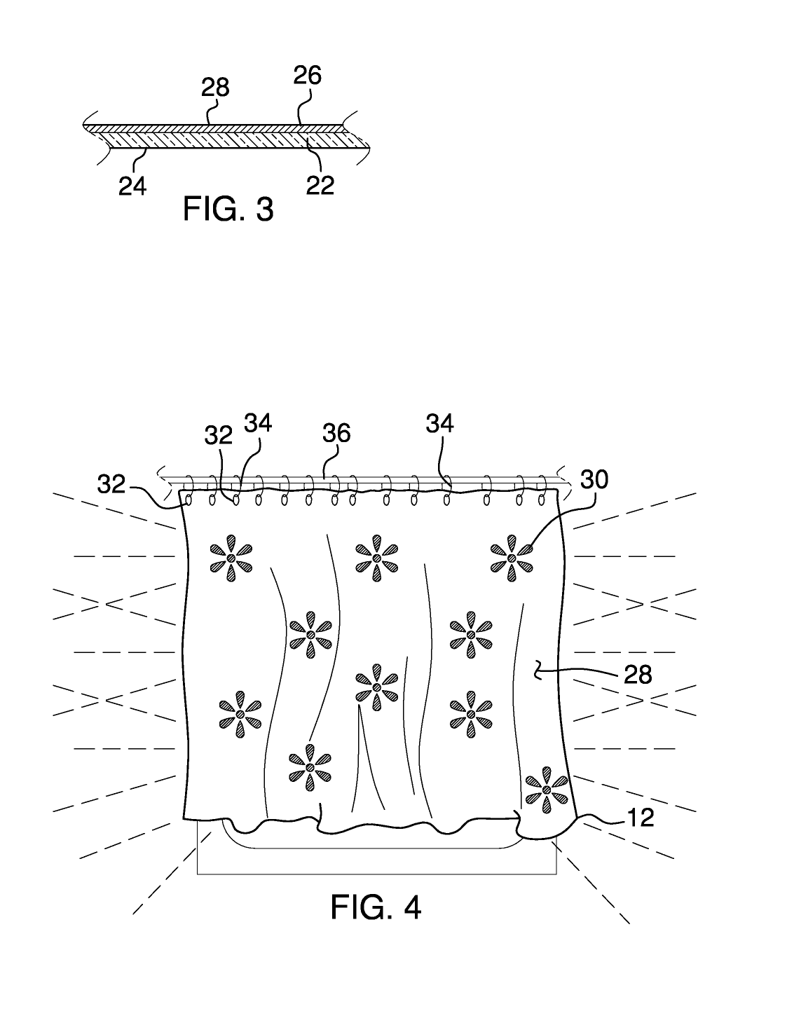

With reference now to the drawings, and in particular to FIGS. 1 through 4 thereof, a new shower curtain device embodying the principles and concepts of an embodiment of the disclosure and generally designated by the reference numeral 10 will be described.

As best illustrated in FIGS. 1 through 4, the light emitting shower curtain assembly 10 generally comprises a panel 12 that is flexible and has an upper edge 14, a bottom edge 16, a first side edge 18 and a second side edge 20. The panel 12 may have a height and width each being greater than 5.0 feet. The panel 12 includes a first layer 22 including a first side 24 and a second layer 26 including a second side 28. The first layer 22 comprises a waterproof material which may be a plastic material. The first layer 22 may be translucent to readily allow light to pass through the first layer 22. The second layer 26 is capable of photoluminescence and may comprise a florescent or phosphorescent material, with the phosphorescent material being preferred for its ability to emit light for long periods after photon absorption. The second layer 26 therefore re-emits absorbed light after the second layer has been exposed to light. The phosphorescent material may be any conventional phosphorescent material. A plurality of indicia 30 may be positioned on the second side. The indicia 30 may or may not also be phosphorescent.

The panel 12 has a plurality of apertures 32 therein extending into the first side 24 and outwardly from the second side 28. The apertures 32 may have reinforced perimeter edges. The apertures 32 are aligned with each other along a line extending through the first 18 and second 20 side edges and which is positioned adjacent to the upper edge 14. The apertures 32 may be used for receiving curtain rings 34 for hanging the panel 12 on a rod 36 in a conventional manner or for receiving a rod 36 directly through the apertures 32.

In use, assembly 10 is used as a conventional shower curtain to prevent water from leaving a bathtub or shower stall while a person is bathing. The panel 12 will absorb light and will then re-emit that light so that the panel 12 is illuminated, particularly after a light within the room in which it is positioned is turned off. The indicia 30 may include aesthetic features or inspirational sayings.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. (canceled)

3. A scent dispersing assembly comprising:
a frame configured to be coupled to an air handler;
a filter coupled to said frame wherein said filter is configured to filter particles from air urged by the air handler;
a pad coupled to said filter, said pad being infused with a scent wherein said pad is configured to release said scent into the air urged by the air handler;
said frame being longitudinally split to define an upper half and a lower half, each of said upper half and said lower half comprising
a respective plurality of arms, each of said arms intersecting to form an open rectangular shape, each of said arms being bent along a lengthwise axis to define a respective first section forming a right angle with a respective second section, and
each of said upper half and said lower half being aligned such that a bottom edge of each of said first sections abuts a top edge of an associated one of said primary sections; and
wherein said filter being longitudinally split to define a top half and a bottom half, each of said top half and said bottom half having a respective outer edge extending between each of a respective top side and a respective bottom side.

4. The assembly according to claim 3, wherein said top half of said filter being positioned such that said top side abuts a bottom surface of said first section of each of said arms of said upper half of said frame wherein said top half is coextensive with said upper half.

5. The assembly according to claim 4, wherein said bottom half of said filter being positioned such that said lower side abuts a topmost surface of said first section of each of said arms said lower half of said frame wherein said bottom half is coextensive with said lower half.

6. The assembly according to claim 5, wherein said pad having an outermost edge extending between each of an uppermost surface and a lowermost surface, said pad being positioned such that said uppermost surface abuts said bottom side of said top half and said lowermost surface abuts said upper side of said bottom half.

7. A scent dispersing assembly comprising:
a frame configured to be coupled to an air handler, said frame being longitudinally split to define an upper half and a lower half, each of said upper half and said lower half comprising
a respective plurality of arms, each of said arms intersecting to form an open rectangular shape, each of said arms being bent along a lengthwise axis to define a respective first section forming a right angle with a respective second section, and
each of said upper half and said lower half being aligned such that a bottom edge of each of said first sections abuts a top edge of an associated one of said primary sections;
a filter coupled to said frame wherein said filter is configured to filter particles from air urged by the air handler, said filter being longitudinally split to define a top half and a bottom half, each of said top half and said bottom half having a respective outer edge extending between each of a respective top side and a respective bottom side;
said top half of said filter being positioned such that said top side abuts a bottom surface of said first section of each of said arms of said upper half of said frame wherein said top half is coextensive with said upper half;
said bottom half of said filter being positioned such that said lower side abuts a topmost surface of said first section of each of said arms said lower half of said frame wherein said bottom half is coextensive with said lower half; and
a pad, said pad having an outermost edge extending between each of an uppermost surface and a lowermost surface, said pad being positioned such that said uppermost surface abuts said bottom side of said top half and said lowermost surface abuts said upper side of said bottom half, said pad being infused with a scent wherein said pad is configured to release said scent into the air urged by the air handler.
